(19) United States
(12) Patent Application Publication
(10) Pub. No.: US 2026/0054634 A1
(43) Pub. Date: Feb. 26, 2026

(54) Tow Dolly Lift

(71) Applicant: John Henderson, Robbins, IL (US)

(72) Inventor: John Henderson, Robbins, IL (US)

(21) Appl. No.: 18/811,966

(22) Filed: Aug. 22, 2024

(51) Int. Cl. B60P 3/12; B66F 5/04

(52) U.S. Cl. CPC B60P 3/127; B66F 5/04

(57) ABSTRACT

A tow dolly lift having a tubular member that is connected to a hydraulic system configured to lift a vehicle. The tubular member includes an extendable arm and a platform body, the hydraulic system includes a pair of hydraulic lifting pistons and a power source, and the tubular member is operably connected to the hydraulic system. In operation, the tubular member raises the vehicle upwardly and extends outwardly from the tow dolly to lower and extend under the vehicle. The tubular member then lifts the vehicle upward onto the tow dolly under hydraulic power. In this way, the tow dolly lift automatically secures the vehicle to the tow dolly. The tow dolly lift is assembled into a tow dolly lift or be a standalone unassembled tow dolly lift kit sold as an aftermarket item.

### CROSS-REFERENCE TO RELATED APPLICATIONS

This U.S. Non-Provisional Patent Application claims the benefit of U.S. Provisional Ser. No. 63/533,818 filed on Aug. 21, 2023. The above identified patent application is herein incorporated by reference in its entirety to provide continuity of disclosure.

### BACKGROUND OF THE INVENTION

The present invention relates to a lift. More specifically, the present invention relates to a tow dolly lift.

When a vehicle is damaged or broken down, it may have to be towed to an auto-repair shop. Depending on the type of damage that the vehicle has sustained, towing the vehicle may be a difficult task. When towing the vehicle, certain types of lifts must be secured to the vehicle's tires. Thus, when a vehicle has a flat or missing tire, towing on specific types of lifts may become difficult. Without an alternative means to lift the vehicle onto the towing dolly, the vehicle will not be able to be transported for the appropriate repairs.

In order to address these concerns, what is needed is a tow dolly lift that utilizes a hydraulic mechanism to automatically lift a vehicle onto a dolly.

### SUMMARY OF THE INVENTION

In view of the foregoing disadvantages inherent in the known types of tow dolly lifts now present in the prior art, the present invention provides a tow dolly lift wherein the same may be utilized for providing convenience for the user when using a tow dolly lift.

The present invention is a tow dolly lift comprising a tubular member having an extendable arm and a platform body, wherein the tubular member is configured to rest upon a tow dolly, a hydraulic system having a pair of hydraulic lifting pistons and a power source, and wherein the tubular member is operably connected to the hydraulic system.

In another embodiment of the present invention, the present invention is a tow dolly lift kit comprising a tubular member having an extendable arm and a platform body, and a hydraulic system having a pair of hydraulic lifting pistons and a power source.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a side perspective view of an embodiment of a tow dolly lift.

FIG. 2 shows an overhead perspective view of an embodiment of the tow dolly lift.

FIG. 3 shows a close-up side perspective view of an embodiment of the tow dolly lift.

FIG. 4 shows an overhead perspective view of an embodiment of the tow dolly lift in use.

FIG. 5 shows an overhead perspective close-up view of an embodiment of the tow dolly lift.

### DETAILED DESCRIPTION OF THE INVENTION

Reference is made herein to the attached drawings. Like reference numerals are used throughout the drawings to depict like or similar elements of the tow dolly lift. The figures are intended for representative purposes only and should not be considered to be limiting in any respect.

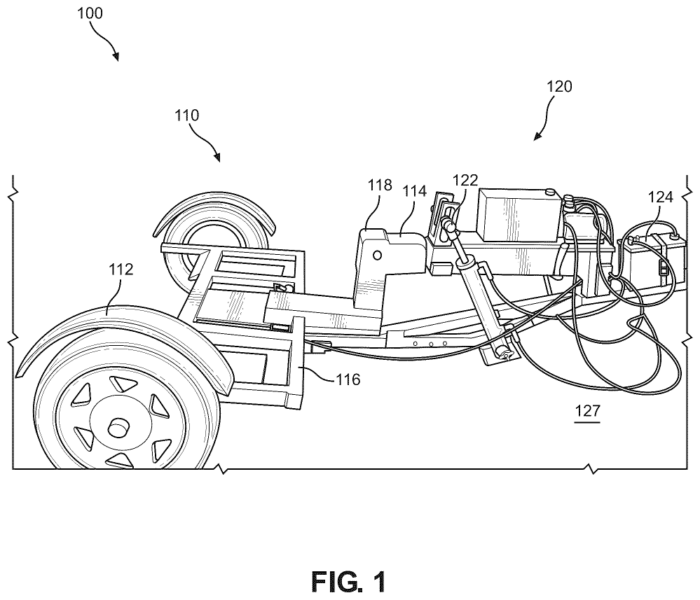

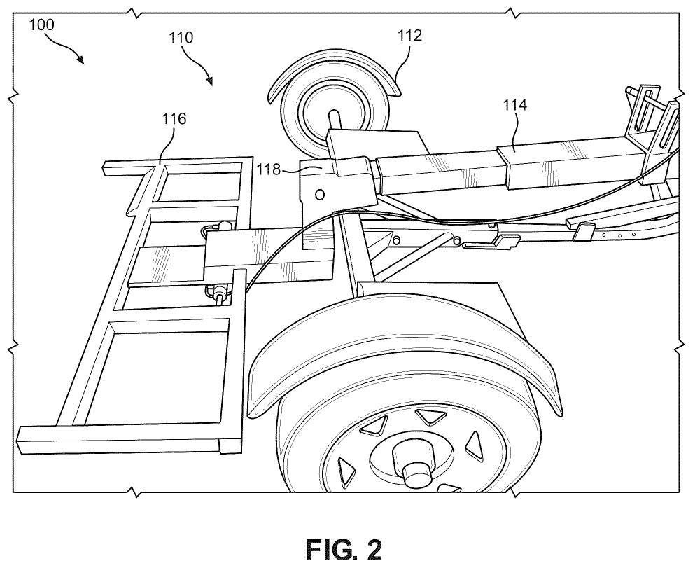

Referring now to FIGS. 1 and 2, there are shown side views of an embodiment of a tow dolly lift 100.

The tow dolly lift 100 may include a tubular member 110 and a hydraulic system 120.

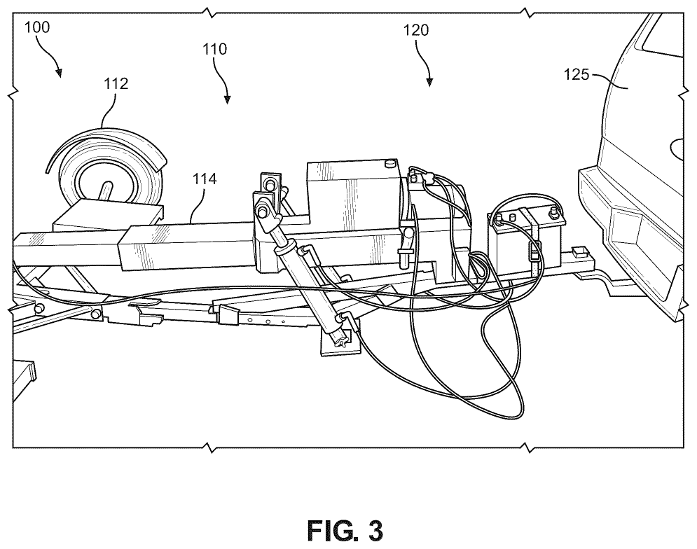

The tubular member 110 may be configured to rest upon a tow dolly 112 or the like. The tubular member 110 may be operably connected to the hydraulic system 120. The tubular member 110 may raise upwardly and extend outwardly from the tow dolly 112. The tubular member 110 may be lower and extend under a vehicle (FIG. 3, 125) that needs to be towed via the hydraulic system 110.

The hydraulic system 120 may include a pair of hydraulic lifting pistons 121, a hydraulic pump 122, a hydraulic fluid reservoir 123, a plurality of hydraulic fluid 124, a control valve 125, a plurality of hydraulic hoses and lines 126, a pressure relief valve 127, and a check valve 128. The hydraulic system 120 may be disposed on opposing ends of the tubular member 110.

The pair of hydraulic lifting pistons 121 may lift and lower the tow dolly 112 by converting hydraulic pressure into mechanical force. The hydraulic pump 122 may generate the hydraulic pressure needed to operate the pair of hydraulic lifting pistons 121 that may be powered by an electric or gas motor (not shown) or the like. The hydraulic fluid reservoir 123 may contain the hydraulic fluid 124 that is used to transmit pressure within the hydraulic system 120. The hydraulic fluid 124 may to transfer force and lubricate the hydraulic system 120. The control valve 125 may regulate the hydraulic fluid 124 to the pair of hydraulic lifting pistons 121, allowing for precise control of a plurality of lifting movements. The hydraulic hoses and lines 126 may be flexible to carry the hydraulic fluid 124 between the hydraulic pump 122, the pair of hydraulic lifting pistons 121, the hydraulic fluid reservoir 123, and the control valve 125. The pressure relief valve 127 may be a safety device that prevents excessive pressure from building-up within the hydraulic hoses and lines 126. The check valve 128 may allow the hydraulic fluid 124 to flow in one direction while preventing it from flowing in the opposite direction to ensure that once the hydraulic fluid 124 has moved into one part of the hydraulic system 120, such as the pair of hydraulic lifting pistons 121, so it cannot flow back to another part of the hydraulic system 120, thereby maintaining the position of the tow dolly 112.

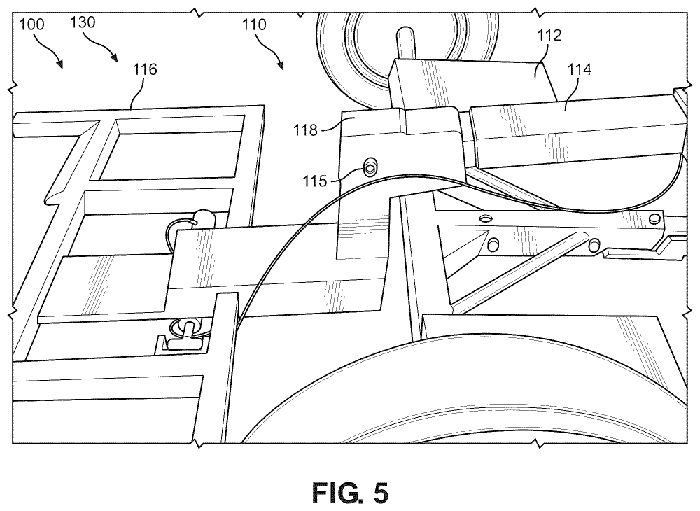

Referring now to FIGS. 3 and 5, there are shown close-up views of an embodiment of the tow dolly lift 100.

In the shown embodiment of the tow dolly lift 100, the tubular member 110 has an extendable arm 114 and a platform body 116. When the hydraulic system 120 may be engaged, the extendable arm 114 may extend the platform body 116 outwardly from the tow dolly 112. The platform body 116 may include an angled attachment end 118 or the like. The angled attachment end 118 may be connected to the extendable arm 114.

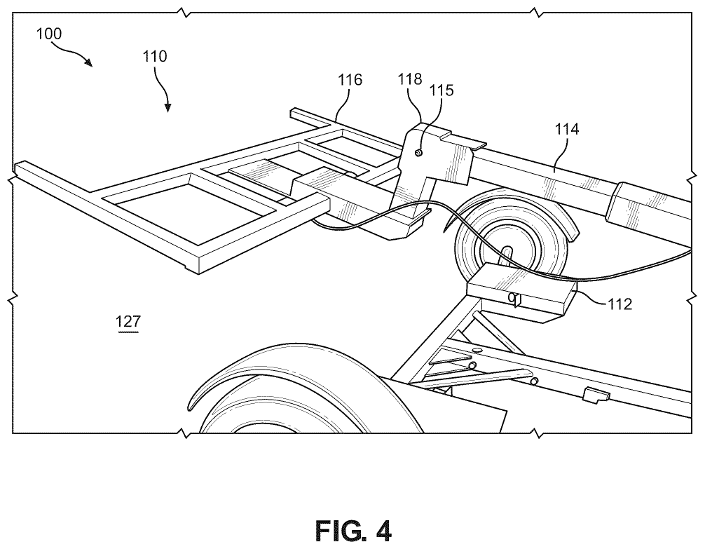

Referring now to FIG. 4, there is shown a perspective view of an embodiment of a tow dolly lift 100 in use.

In use, the user will place the tubular member 110 beneath the vehicle 125. When the hydraulic system 120 is activated, the tubular member 110 will begin to raise. Consequentially, the vehicle 125 may be lifted from the ground or a ground surface 127. The tubular member 110 may maintain support underneath the vehicle 125. Once lifted, the vehicle 125 may be placed upon the tow dolly 112. The vehicle 125 placed upon the tow dolly 112 may then be transported to the desired destination.

Referring now to FIG. 4, there is shown a perspective view of an embodiment of a tow dolly lift 100.

The extendable arm 114, the platform body 116, and the angled attachment end 118 may be welded and fastened together or the like. More specifically, the extendable arm 114 and the platform body 116 may be welded together or the like. The angled attachment end 118 may be connected to the extendable arm 114 by a fastener 115 selected from the group consisting of a bolt, a screw, a rivet or the like.

The tow dolly lift 100 may include a tow dolly lift kit 130 that may include a tubular member 110 and a hydraulic system 120 and their respective components that are unassembled and may be purchased as an aftermarket product.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A tow dolly lift, comprising:
a tubular member having an extendable arm and a platform body;
wherein the tubular member is configured to rest upon a tow dolly; and
a hydraulic system having a pair of hydraulic lifting pistons, a hydraulic pump, a hydraulic fluid reservoir, a plurality of hydraulic fluid, a control valve, a plurality of hydraulic hoses and lines, a pressure relief valve, and a check valve;
wherein the tubular member is operably connected to the hydraulic system.

2. The tow dolly lift, according to claim 1, wherein the tubular member is lowered and extended under a vehicle that needs to be towed via the hydraulic system.

3. The tow dolly lift, according to claim 1, wherein the hydraulic system is engaged and the extendable arm extends the platform body outwardly from the tow dolly.

4. The tow dolly lift, according to claim 1, wherein the platform body includes an angled attachment end.

5. The tow dolly lift, according to claim 4, wherein the angled attachment end is connected to the extendable arm.

6. The tow dolly lift, according to claim 1, wherein the angled attachment end is connected to the extendable arm by a fastener selected from the group consisting of a bolt, a screw, or a rivet.

7. The tow dolly lift, according to claim 1, wherein the extendable arm and the platform body are welded together.

8. The tow dolly lift, according to claim 1, wherein the pair of hydraulic lifting pistons are disposed on opposing ends of the tubular member.

9. The tow dolly lift, according to claim 1, wherein the power source is operably connected to the pair of hydraulic lifting pistons.

10. The tow dolly lift, according to claim 1, further comprising a tow dolly lift kit that includes the tubular member and the hydraulic system that are unassembled and are purchased as an aftermarket product.

11. A tow dolly lift kit, comprising:
a tubular member having an extendable arm and a platform body; and
a hydraulic system having a pair of hydraulic lifting pistons, a hydraulic pump, a hydraulic fluid reservoir, a plurality of hydraulic fluid, a control valve, a plurality of hydraulic hoses and lines, a pressure relief valve, and a check valve.

12. The tow dolly lift kit, according to claim 11, wherein the tubular member is lowered and extended under a vehicle that needs to be towed via the hydraulic system.

13. The tow dolly lift kit, according to claim 12, wherein the tubular member is configured to rest upon a tow dolly.

14. The tow dolly lift kit, according to claim 11, wherein the hydraulic system is engaged and the extendable arm extends the platform body outwardly from the tow dolly.

15. The tow dolly lift kit, according to claim 11, wherein the platform body includes an angled attachment end.

16. The tow dolly lift kit, according to claim 15, wherein the angled attachment end is connected to the extendable arm.

17. The tow dolly lift kit, according to claim 11, wherein the angled attachment end is connected to the extendable arm by a fastener selected from the group consisting of a bolt, a screw, or a rivet.

18. The tow dolly lift kit, according to claim 11, wherein the extendable arm and the platform body are welded together.

19. The tow dolly lift kit, according to claim 11, wherein the pair of hydraulic lifting pistons are disposed on opposing ends of the tubular member.

20. The tow dolly lift kit, according to claim 11, wherein the power source is operably connected to the pair of hydraulic lifting pistons.
